(19) United States
(12) Patent Application Publication
(10) Pub. No.: US 2002/0042287 A1
(43) Pub. Date: Apr. 11, 2002

(54) Cellular phone

(76) Inventor: Kousuke Asami, Saitama (JP)

Correspondence Address: MICHAEL BEST & FRIEDRICH LLC, 401 North Michigan Avenue, Chicago, IL, 60611, US

(21) Appl. No.: 09/975,102

(22) Filed: Oct. 11, 2001

(30) Foreign Application Priority Data
Oct. 11, 2000 (JP) 311119/2000

(51) Int. Cl. H04M 1/00

(52) U.S. Cl. 455/550; 455/556

(57) ABSTRACT

A cellular phone for interchanging information with a base station by radio of the present invention includes a first speaker for selectively outputting a received speech or sound and a second speaker for outputting sound. A controller controls the output of a received speech or sound from the first and second speakers in accordance with sound setting selected beforehand by the user of the phone.

### BACKGROUND OF THE INVENTION

1. Field of the Invention

The present invention relates to a cellular phone for interchanging information with a base station included in a mobile communication system.

2. Description of the Background Art

A modern cellular phone usually includes speakers for outputting a call incoming tone and a received speech and a memory for storing, e.g., call incoming tone data. More specifically, one of the speakers is assigned to a call incoming tone while the other speaker is assigned to a received speech and, in this sense, plays the role of a receiver. For the speaker assigned to sound, a speaker capable of outputting sound over a board frequency band is often used to meet the demand for a variety of call incoming tones.

In parallel with the increase in the functions available with a cellular phone, the capacity of the above-mentioned memory is increasing to such a degree that even music or speeches can be recorded in the phone. This allows the user of the phone to reproduce music distributed via a music distributing machine or Internet on the phone.

To allow the user of the cellular phone to reproduce music on the phone, the phone may be configured such that music based on music data is output from the speaker assigned to sound and higher in performance than the speaker assigned to a received speech. Such a configuration, however, does not provide the music with a stereophonic effect. While two speakers may be installed in the phone to output stereophonic sound, they increase the size and weight of the phone, which should be small size and light weight.

Technologies relating to the present invention are disclosed in, e.g., Japanese Patent Laid-Open Publication Nos. 1-120159, 4-243358, 6-37920, 10-23115, and 10-233826.

### SUMMARY OF THE INVENTION

It is an object of the present invention to provide a cellular phone capable of outputting stereophonic sound while maintaining a small size, lightweight configuration.

A cellular phone for interchanging information with a base station by radio of the present invention includes a first speaker for selectively outputting a received speech or sound and a second speaker for outputting sound. A controller controls the output of a received speech or sound from the first and second speakers in accordance with sound setting selected beforehand by the user of the phone.

### BRIEF DESCRIPTION OF THE DRAWINGS

The above and other objects, features and advantages of the present invention will become more apparent from the following detailed description taken with the accompanying drawings in which:

FIG. 1 is an exploded isometric view showing a cellular phone embodying the present invention;

FIG. 2 is a schematic block diagram showing electric circuitry included in the illustrative embodiment;

FIG. 3 is a schematic block diagram showing a specific configuration of a speech output switching controller included in the circuitry of FIG. 2; and

FIGS. 3 and 4 are flowcharts demonstrating a specific operation of the illustrative embodiment.

### DESCRIPTION OF THE PREFERRED EMBODIMENT

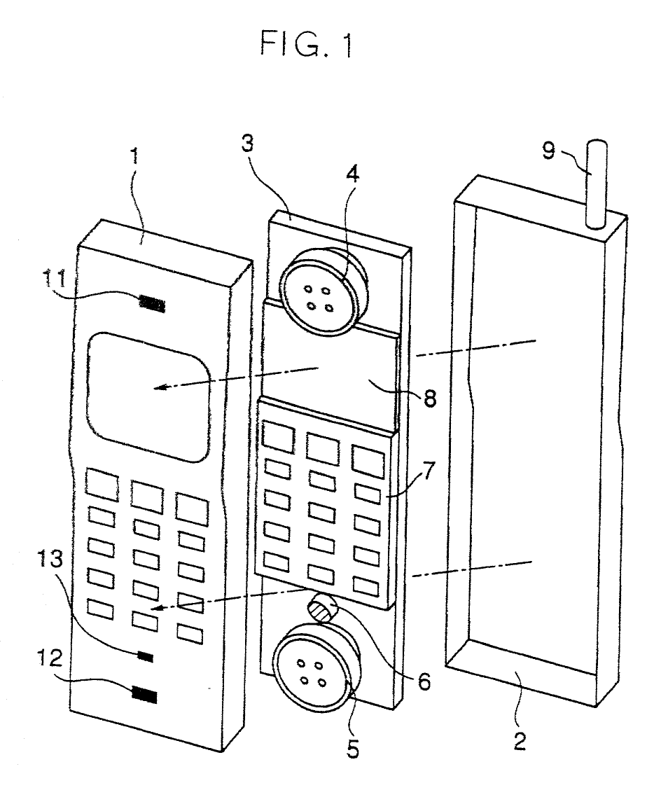

Referring to FIG. 1 of the drawings, a cellular phone embodying the present invention is shown and includes a circuit board 3. A first and a second speaker 4 and 5, respectively, a microphone 6, an operation panel 7 and a display 8 are mounted on the circuit board 3. The first speaker 4 selectively outputs a received speech or sound including a call incoming tone and music. The second speaker 5 outputs only sound. The first and second speakers 4 and 5 are spaced from each other on one major surface of the circuit board 3 so as to implement a stereophonic effect. The speaker 4 is positioned such that when the user of the phone converses on the phone, the speaker 4 faces the user's ear. During conversation, the user's voice is input to the microphone 6. The display 8 is implemented as, e.g., an LCD (Liquid Crystal Display) and displays various text information including phone numbers as well as graphic information. The user may operate the operation panel 7 in order to input various kinds of information including a phone number. Electric circuits for executing various operations required of the cellular phone are also arranged on the circuit board 3. The speakers 4 and 5 are equivalent in performance to each other.

A front case 1 is formed with holes 11, 12 and 13 corresponding in position to the speakers 4 and 5 and microphone 6, respectively. The front case 1 includes a transparent portion corresponding to the display 8. Further, a group of holes are formed in the front case 1 and correspond to a group of keys arranged on the operation panel 7. An antenna 9 is mounted on a rear case 2 and connected to the circuit board 3. The front and rear cases 1 and 2 are put together with the circuit board 3 intervening therebetween. At this instant, the surface of the circuit board 3 loaded with the various electric parts and circuits faces the front case 1.

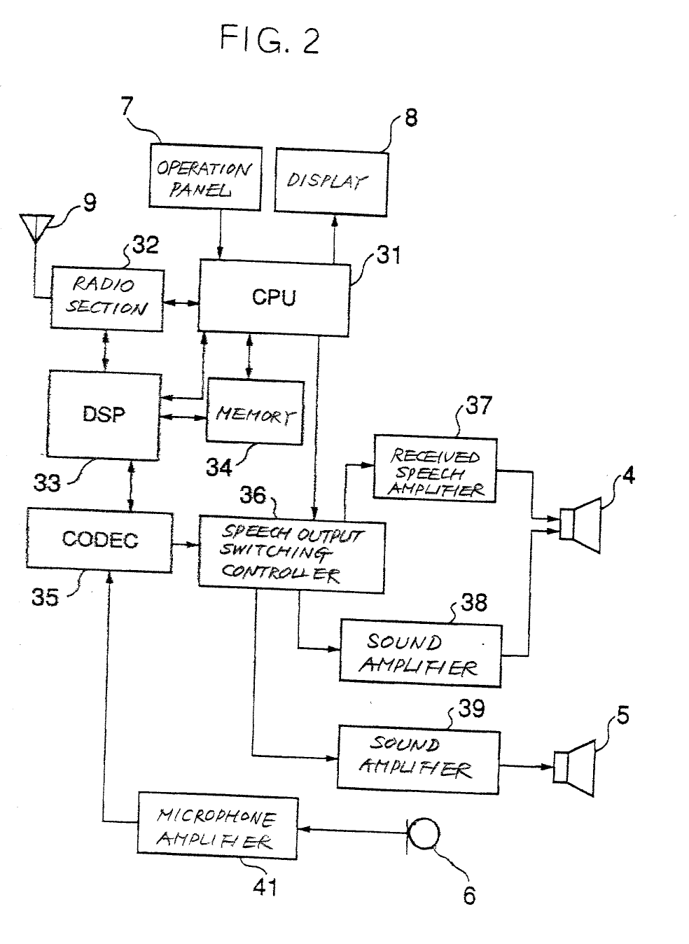

FIG. 2 shows electric circuitry included in the illustrative embodiment. As shown, the circuitry includes a CPU (Central Processing Unit) 31 for receiving various signals including key input signals from the operation panel 7. The CPU 31 delivers a display command and a switch command to the display 8 and a speech output switching controller 36, respectively. Further, the CPU 31 interchanges information with a DSP (Digital Signal Processor) or signal processor 33 and a memory 34. The memory 34, which plays the role of a speech memory, may be implemented by an EEPROM (Electrically Erasable Programmable Read Only Memory) by way of example. In addition, the CPU 31 executes various kinds of control required of the phone. In the illustrative embodiment, the CPU 31 and speech output switching controller 36 constitute a controller in combination.

The DSP 33 interchanges information with the CPU 31 and memory 34 as well as with a radio section 32 and a CODEC (Coder/Decoder) 35. The CODEC 35 includes an AD (Analog-to-Digital) converter and a DA (Digital-to-Analog) converter. The memory 34 stores various data including call incoming tone data and is capable of storing other data including music data received via, e.g., Internet. The radio section 32 amplifies power and converts frequency in order to communicate with a base station, which is included in a mobile communication system, via the antenna 9. The DSP 33 corrects the characteristic of a received signal, sets up a radio channel between the cellular phone and a base station, switches a conversation channel, and processes a speech signal.

The speech output switching controller 36 is connected to a received speech amplifier 37 and sound amplifiers 38 and 39 as well as to the CPU 31 and CODEC 35. The switching controller 36 executes volume control and amplifier switching control in accordance with a command output from the CPU 31. The received speech amplifier 27 and sound amplifier 38 are connected to the first speaker 4 while the sound amplifier 39 is connected to the second speaker 5. The sound amplifiers 38 and 39 each have a greater amplification ratio than the received speech amplifier 37. More specifically, sound output from the speaker 4 via the sound amplifier 38 and sound output from the speaker 5 via the sound amplifier 39 each have a greater maximum volume that a speech output from the speaker 4 via the received speech amplifier 37. It is to be noted that a received speech refers to the voice of the user of another cellular phone communicating with the cellular phone of the illustrative embodiment.

The microphone 6 transforms a speech input thereto to a speech signal. A microphone amplifier 41 amplifies the speech signal output from the microphone 6 and feeds the amplified speech signal to the CODEC 35.

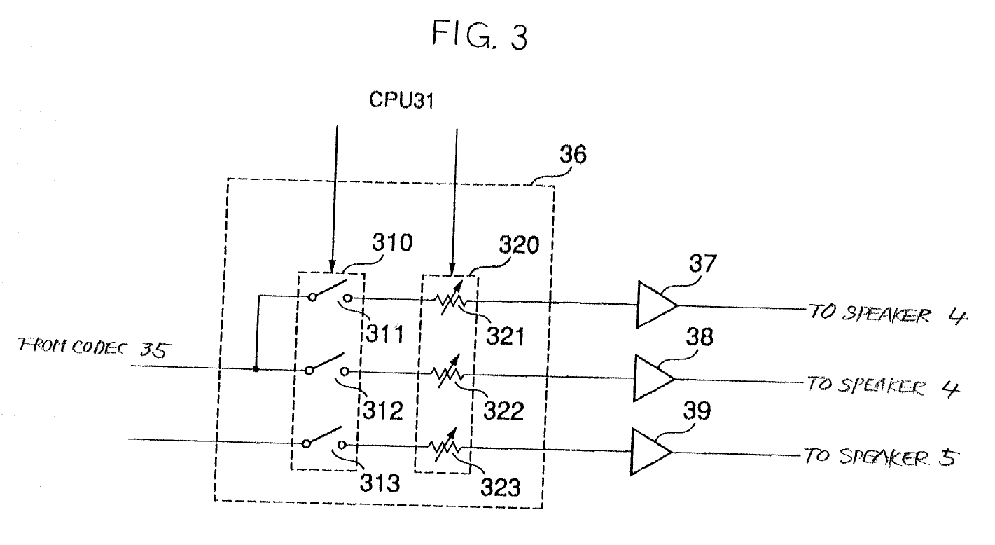

FIG. 3 shows a specific configuration of the speech output switching controller 36. As shown, the switching controller 36 includes a group of switches 311 through 313 and a group of volumes 321 through 323. The switches 311 through 313 and volumes 321 and 323 are generally designated by the reference numerals 310 and 320, respectively. The volumes 321 through 323 are electronic volumes whose resistance is variable under electric control.

The switches 311 and 312 are connected to one output of the CODEC 35 at one end thereof. The volume 321 has an input connected to the other end of the switch 311 and has an output connected to the input of the received speech amplifier 37. The volume 322 has an input connected to the other end of the switch 312 and has an output connected to the input of the sound amplifier 38. The switch 313 is connected to the other output of the CODEC 35 at one end thereof. The volume 323 has an input connected to the other end of the switch 313 and has an output connected to the input of the sound amplifier 39.

The switching controller 36 selectively turns on or turns off each of the switches 311 through 313 and varies the resistance of each of the volumes 321 through 323 in accordance with a command output from the CPU 31. The CODEC 35 produces a particular signal from each of its two outputs when a stereophonic effect is desired or produces the same signal from the two outputs when such an effect is not desired.

In the illustrative embodiment, the speaker 4 is operable in two different modes, i.e., a received speech mode and a sound mode. Selection of one of these two modes will be referred to as sound setting. When the received speech mode is selected, the speaker 4 is caused to output a received speech with a speech volume set beforehand. When the sound mode is selected, the speaker 4 is caused to output sound with a preselected call incoming tone volume. As for sound setting, a particular mode, e.g., the received speech mode is set at the time of, e.g., shipment. The user of the phone can select a desired speech volume and a desired call incoming tone volume on the phone. Further, the user can select a desired pattern of call incoming tones. The speech volume refers to the volume of a received speech output via the speaker 4 while the call incoming tone volume refers to the volume of sound output via the speaker 5. When the user selects the sound mode available with the speaker 4, the speaker 4 is controlled to the same volume as the speaker 5. In the illustrative embodiment, the volume of the speaker 4 is sometimes raised to the volume of the speaker 5 stepwise, as will be described specifically later. The maximum volume of a call incoming tone, or sound, is greater than the maximum volume of a received speech.

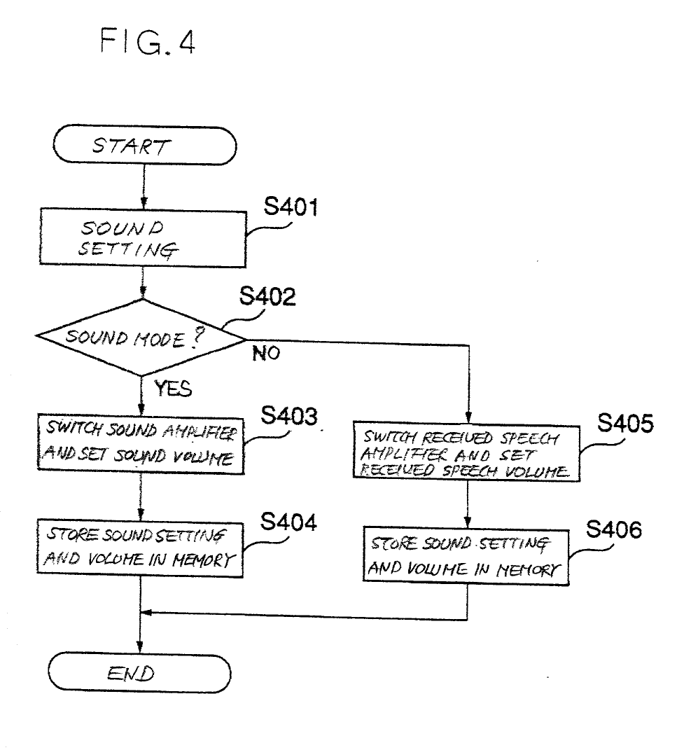

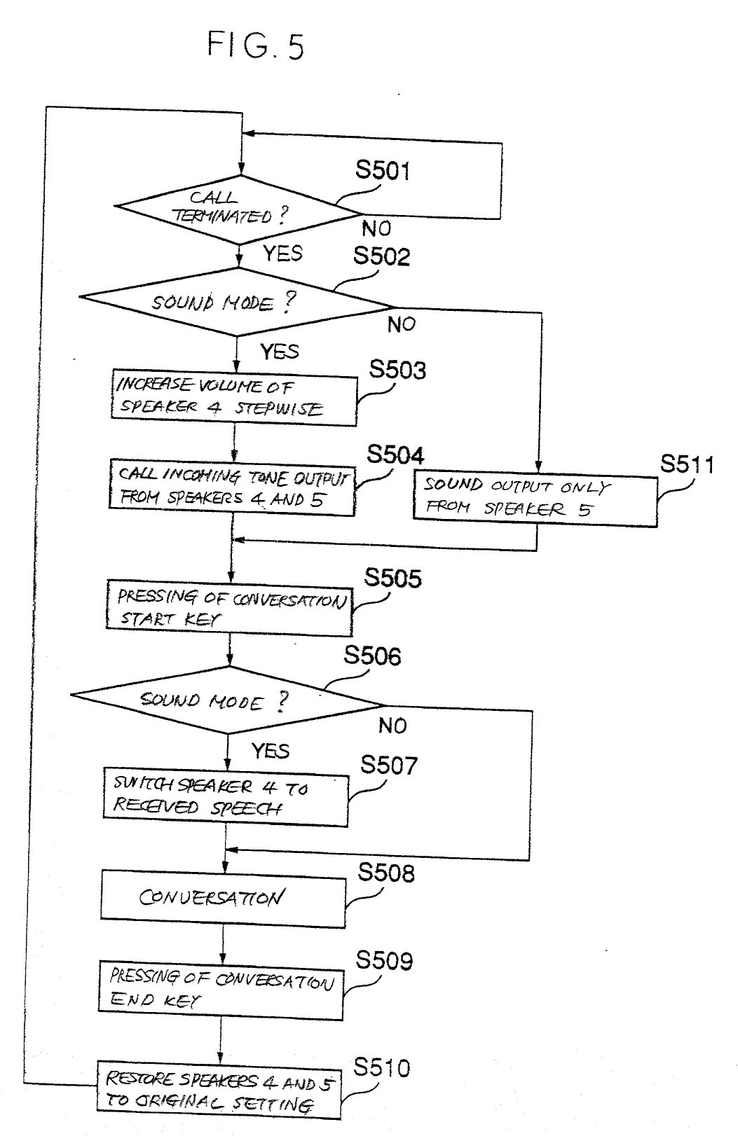

The user can perform sound setting and select a desired speech volume and a desired call incoming tone volume when the phone is in a standby state or when conversation or music reproduction is under way. A specific operation of the illustrative embodiment will be described with reference to FIG. 4 as well as to FIG. 3. When the user presses a particular key, e.g., a menu key positioned on the operation panel 7, the CPU 31 displays a menu picture on the display 8. As shown in FIG. 4, the user, watching the menu picture, selects “sound setting” by moving a cursor by way of example (step S401). The user may additionally select a desired speech volume and a desired call incoming tone volume. The operation panel 7 delivers the results of user's selection to the CPU 31. In response, the CPU 31 determines whether or not the user has selected the sound mode available with the speaker 4 (step S402).

Assume that the user has selected the sound mode (YES, step S402). Then, the CPU 31 causes the speech output switching controller 36 to select a call incoming tone by feeding a command to the switching controller 36 (step S403). In response, the switching controller 36 turns off the switch 311 and turns on the switch 312 to thereby deliver the output of the CODEC 35 to the speaker 4 via the sound amplifier 38. In addition, the switching controller 36 controls the resistance of the volume 322 in order to implement the call incoming tone volume selected beforehand. The CPU 31 writes the sound setting and volume selected in the memory 34 (step S404).

Assume that the user has not selected the sound mode, i.e., has selected the received speech mode also available with the speaker 4 (NO, step S402). Then, the CPU 31 controls the speech output switching controller 36 such that a received speech will be output from the speaker 4 with the speech volume selected beforehand (step S405). Specifically, the switching controller 36 turns on the switch 311 and turns off the switch 312 such that the output of the CODEC 35 is fed to the speaker 4 via the received speech amplifier 37. Further, the switching controller 36 controls the resistance of the volume 321 in order to cause the speaker 4 to output a received speech with the speech volume selected beforehand. The CPU 31 writes the sound setting and volume selected in the memory 34 (step S406).

In the illustrative embodiment, when the cellular phone is in a standby state, the switch 313 is turned on while the resistance of the volume 323 is set at a value corresponding to the preselected call incoming tone volume. In this condition, the output of the CODEC 35 is fed to the speaker 5 via the sound amplifier 39.

A procedure to follow the termination of a call will be described with reference to FIG. 5. As shown, assume that the radio section 32 detects a call terminated at the cellular phone (YES, step S501). Then, the radio section 32 delivers a call termination signal to the CPU 31. The CPU 31, detected the call termination signal (YES, step S501), reads the sound setting out of the memory 34 and then determines whether or not the sound mode available with the speaker 4 is selected (step S502).

Assume that the sound mode is selected (YES, step S502). Then, the route from the CODEC 35 to the two sound amplifiers 38 and 39 has already been set up while the call incoming tone volume selected beforehand has already been assigned to the speakers 4 and 5. In this case, the CPU 31 causes the speech output switching controller 36 to vary the resistance of the volume 322 at preselected intervals such that the volume of the speaker 4 approaches the volume (call incoming tone volume) of the speaker 5 stepwise.

The CPU 31 causes the DSP 33 to read call incoming tone data out of the memory 34 and causes it to generate a call incoming signal in a stereophonic fashion. Alternatively, the CPU 31 may cause the DSP 33 to generate the call incoming signal in a dual monaural fashion such that the same sound is output from both of the speakers 4 and 5. The DSP 33 reads the call incoming tone data out of the memory 34, generates a call incoming signal, and feeds the call incoming signal to the CODEC 35. The CODEC 35 converts the digital call incoming signal to an analog signal and delivers the analog signal to the speech output switching controller 36.

The speech output switching controller 36 controls the resistance of the volume 322 step wise in order to increase the volume of sound to be output from the speaker 4 stepwise (step S503), as instructed by the CPU 31. While the call incoming tone is output from both of the speakers 4 and 5, the volume of the tone output from the speaker 4 increases stepwise to the call incoming tone volume selected beforehand (step S504). This prevents the call incoming tone from being abruptly output from the speaker or receiver 4 with a great volume and thereby frees the user from unpleasantness.

Assume that the received speech mode available with the speaker 4 is selected (NO, step S502). Then, the CPU 31 causes the speech output switching controller 36 to turns off the switch 311 so as to prevent the call incoming tone from being output from the speaker 4. More specifically, in this case, the route from the CODEC 35 to the sound amplifier 39 has already been set up. Consequently, the output signal of the DSP 33 is delivered only to the speaker 5, i.e., the call incoming tone is output only from the speaker 5 (step S511). This informs the user of the call terminated at the phone.

The user, recognized the call, presses a particular key, i.e., a conversation start key positioned on the operation panel 7 for thereby off-hooking the phone (step S505). In response, the CPU 31 causes the DSP 33 to stop outputting the call incoming tone from the speakers 4 and 5. Further, the CPU 31 causes the speech output switching controller 36 to restore the group of switches 310 to the condition matching with the sound setting stored in the memory 34.

Subsequently, the CPU 31 reads the sound setting out of the memory 34 and then determines whether or not the sound mode available with the speaker 4 is selected (step S506). If the sound mode is selected (YES, step S506), then the speech output switching controller 36 has already set up the route from the CODEC 35 to the two sound amplifiers 38 and 39. The CPU 31 therefore causes the switching controller 36 to output a speech from the speaker 4 with the speech volume selected. More specifically, the switching controller 36 turns on the switch 311 and turns off the switches 312 and 313 in order to deliver the output signal or received speech signal of the CODEC 35 only to the received speech amplifier 37 (step S507).

Further, the CPU 31 cause the DSP 33 to process a speech signal received via the radio section 32 and feeds the processed speech signal to the CODEC 35. The CODEC 35 converts the speech signal to an analog speech signal and feeds the analog speech signal to the speech output switching controller 36. The analog speech signal is input to the speaker 4 via the switch 311 of the switching controller 36 and received speech amplifier 37 because the switches 312 and 313 have been turned off.

The microphone 6 transforms the user's voice input thereto to a speech signal. The microphone amplifier 41 amplifies the speech signal and feeds the amplified speech signal to the CODEC 35. The CODEC 35 digitizes the speech signal and delivers a digital speech signal to the DSP 33. The DSP 33 processes the digital speech signal and feeds the processed digital speech signal to the radio section 32. The radio section 32 sends the processed digital speech signal to a base station. In this manner, conversation is held between the user and the other party (step S508).

Assume that the sound setting is not the sound mode available with the speaker 4 (NO, step S506). Then, the CPU 31 causes the speech output switching controller 36 to turn off the switch 313. In this case, the route from the CODEC 35 to the received speech amplifier 37 has already been set up. Therefore, the output signal or received speech signal of the CODEC 35 is input to the speaker 4 via the received speech amplifier 37. Consequently, the received speech is output only from the speaker 4, setting up conversation (step S508). After the conversation has been set up, the illustrative embodiment causes the speech output switching controller 36 to turn off the switch 313, as stated above. This control over the switch 313 is not necessary if the CODEC 35 is configured to output the received speech signal on only one output thereof, which is connected to the switches 311 and 312.

On completing conversation, the user presses a particular key, e.g., a conversation end key for thereby on-hooking the phone (step S509). In response, the CPU 31 causes the speech output switching controller 36 to restore the group of switches 310 to the condition matching with the sound setting stored in the memory 34 (step S510). Thereafter, the procedure returns to the step S501.

A procedure for reproducing music data stored in the memory 34 will be described hereinafter. When the phone is connectable to, e.g., Internet, it is capable of receiving music data via Internet. Music data received is written to the memory 34 in the same manner as call incoming tone data. Today, even music data distribution services are available at, e.g., convenience stores and record stores for recording various kinds of music data in MDs (Mini Disks) or similar disks. Even the cellular phone is capable of receiving music data at such a spot if provided with a function of downloading the music data, as will be described hereinafter.

To reproduce the music data stored in the memory 34, the user presses the menu key or similar preselected key on the operation panel 7. In response, the CPU 31 displays various kinds of selection menus on the display 8. When the user selects a music play menu, the CPU 31 designates music data to be reproduced in accordance with the user's selection.

Further, by varying the sound setting, the user can enjoy music based on the music data and output from both of the speakers 4 and 5. For example, assume that the user switches the sound setting to the sound mode available with the speaker 4. Then, the volume of the speaker 4 is control led to the volume of the speaker 5 while the output signal of the CODEC 35 is delivered to the speakers 4 and 5 via the sound amplifiers 38 and 39, respectively. When the user performs a preselected operation for reproducing the music, the CPU 31 causes the DSP 33 to reproduce the designated music data. More specifically, the DSP 33 reads the music data out of the memory 34 and generates a music signal in the same manner as when generating the call incoming tone signal. The music signal is delivered to the speakers 4 and 5 via the CODEC 35, speech output switching controller 36, and sound amplifiers 38 and 39. As a result, sound is output form both of the speakers 4 and 5 with the call incoming tone volume in accordance with the music signal.

At the time of music reproduction, the CPU 31 does not cause the switching controller 36 to increase the volume of the speaker 4 stepwise. Therefore, sound is immediately output from the speaker 4 with the call incoming tone volume selected beforehand. The user may select a greater call incoming tone volume to enjoy the music with a greater volume, if desired.

The music output from both of the speakers 4 and 5 provides the user with a stereophonic effect. It is to be noted that when the user inputs a music play command on the operation panel 7, the CPU 31 may automatically switch the sound setting to the sound mode available with the speaker 4.

While the illustrative embodiment reproduces music data by using the sound setting, it may be modified to reproduce music data without regard to the sound setting, if desired. For example, the phone may be configured to allow the user to select a desired sound volume independently of the call incoming tone volume, in which case the phone will reproduce music data with the desired sound volume in place of the preselected call incoming tone volume. Further, the phone may be configured to allow the user to select the speaker 5, the speakers 4 and 5 or the speaker 5 for the reproduction of music data. In addition, the user, when selected the speaker 4 for the reproduction of music data, may select the speech volume so as to enjoy music in the same manner as usual conversation.

As stated above, the phone includes the speakers 4 and 5 each of which can output sound with a volume greater than the speech volume. The phone can therefore output a call incoming tone or music with a stereophonic effect. Particularly, the stereophonic effect is enhanced because the speakers 4 and 5 are spaced from each other on the same surface that faces the front case 1.

Further, the user can enjoy stereophonic music only if a speaker conventionally mounted on a cellular phone is replaced with the speaker 4 shared by speeches and sound. This can be done without resorting to any extra audio part or any extra mounting space. The illustrative embodiment can therefore output stereophonic sound despite its size equivalent to the size of a conventional cellular phone.

Moreover, the illustrative embodiment causes a call incoming tone to be output from the speaker 4 with a volume increasing stepwise, i.e., prevents a call incoming tone from being abruptly output with a great volume. The user is therefore free from unpleasantness.

In summary, in accordance with the present invention, a cellular phone includes a first speaker capable selectively outputting a received speech or sound and a second speaker capable of outputting sound. A controller causes sound to be selectively output from one or both of the first and second speakers in accordance with sound setting selected by the user of the phone. The phone of the present invention can therefore output stereophonic sound, e.g., a stereophonic call incoming tone. Further, the first speaker can be implemented by the speaker of a conventional cellular phone only if a function of outputting sound, as distinguished from a speech, is added to the speaker. The phone of the present invention can therefore output stereophonic sound with a size and a weight comparable with those of the conventional cellular phone.

Various modifications will become possible for those skilled in the art after receiving the teachings of the present disclosure without departing from the scope thereof.

What is claimed is:

1. A cellular phone for interchanging information with a base station included in a mobile communication system by radio, said cellular phone comprising:
a first speaker for selectively outputting a received speech or sound;
a second speaker for outputting sound; and
a controller for controlling output of a received speech or sound from said first speaker and said second speaker in accordance with sound setting selected beforehand.

2. The phone as claimed in claim 1, wherein the sound setting is to cause said first speaker to output a received speech or to cause said first speaker to output sound.

3. The phone as claimed in claim 2, further comprising:
a received speech amplifier and a sound amplifier connected to said first speaker for amplifying a received speech and sound, respectively; and
a sound amplifier connected to said second speaker for amplifying sound.

4. The phone as claimed in claim 3, wherein when said first speaker is assigned to a received speech, said controller causes a call incoming signal to be input only to said sound amplifier connected to said second speaker.

5. The phone as claimed in claim 4, wherein during conversation, said controller causes a received speech signal to be input only to said sound amplifier connected to said first speaker.

6. The phone as claimed in claim 5, further comprising a speech memory for storing speech data, wherein said controller causes, when said speech data should be reproduced, a speech signal to be input to said sound amplifier connected to said first speaker and said sound amplifier connected to said second speaker.

7. The phone as claimed in claim 6, further comprising:
a radio section for interchanging information with a remote station via an antenna;
a memory for storing data;
a signal processor for executing preselected processing with a signal received via said radio section or reading data out of said memory to thereby generate a signal corresponding to said data; and
a digital-to-analog converter for digitizing an output signal of said signal processor and delivering a resulting digital signal to said controller.

8. The phone as claimed in claim 3, wherein when said first speaker is assigned to sound, said controller causes a call incoming tone signal to be fed to said sound amplifier connected to said first speaker and said sound amplifier connected to said second speaker.

9. The phone as claimed in claim 8, wherein said controller causes a volume of the call incoming signal output from said first speaker to increase stepwise

10. The phone as claimed in claim 1, further comprising:
a received speech amplifier and a sound amplifier connected to said first speaker for amplifying a received speech and sound, respectively; and
a sound amplifier connected to said second speaker for amplifying sound.

11. The phone as claimed in claim 10, wherein when said first speaker is assigned to a received speech, said controller causes a call incoming signal to be input only to said sound amplifier connected to said second speaker.

12. The phone as claimed in claim 11, wherein during conversation, said controller causes a received speech signal to be input only to said sound amplifier connected to said first speaker.

13. The phone as claimed in claim 12, further comprising a speech memory for storing speech data, wherein said controller causes, when said speech data should be reproduced, a speech signal to be input to said sound amplifier connected to said first speaker and said sound amplifier connected to said second speaker.

14. The phone as claimed in claim 13, further comprising:
a radio section for interchanging information with a remote station via an antenna;
a memory for storing data;
a signal processor for executing preselected processing with a signal received via said radio section or reading data out of said memory to thereby generate a signal corresponding to said data; and
a digital-to-analog converter for digitizing an output signal of said signal processor and delivering a resulting digital signal to said controller.

15. The phone as claimed in claim 10, wherein when said first speaker is assigned to sound, said controller causes a call incoming tone signal to be fed to said sound amplifier connected to said first speaker and said sound amplifier connected to said second speaker.

16. The phone as claimed in claim 15, wherein said controller causes a volume of the call incoming signal output from said first speaker to increase stepwise

17. The phone as claimed in claim 1, further comprising:
a radio section for interchanging information with a remote station via an antenna;
a memory for storing data;
a signal processor for executing preselected processing with a signal received via said radio section or reading data out of said memory to thereby generate a signal corresponding to said data; and
a digital-to-analog converter for digitizing an output signal of said signal processor and delivering a resulting digital signal to said controller.
